(19) United States
(12) Patent Application Publication
(10) Pub. No.: US 2025/0166394 A1
(43) Pub. Date: May 22, 2025

(54) SIGNAL INFORMATION RECOGNITION METHOD, DEVICE, AND COMPUTER PROGRAM FOR AUTONOMOUS DRIVING OF VEHICLE

(71) Applicant: RideFlux Inc., Jeju-si (KR)

(72) Inventors: Hawook JEONG, Seoul (KR); Heekon KIM, Jeju-si (KR); Bumjoon PARK, Jeju-si (KR); Hyunkun KIM, Jeju-si (KR)

(73) Assignee: RideFlux Inc., Jeju-si (KR)

(21) Appl. No.: 19/029,908

(22) Filed: Jan. 17, 2025

Related U.S. Application Data
(63) Continuation of application No. PCT/KR2023/001371, filed on Jan. 31, 2023.

(30) Foreign Application Priority Data
Aug. 16, 2022 (KR) 10-2022-0102109

(51) Int. Cl. G06V 20/58; G06V 10/25; G06V 10/26; G06V 10/764; G06V 10/774

(52) U.S. Cl. CPC G06V 20/584; G06V 10/25; G06V 10/26; G06V 10/764; G06V 10/774

(57) ABSTRACT

Provided are a signal information recognition method, device, and computer program for the autonomous driving of a vehicle. The signal information recognition method for the autonomous driving of a vehicle is performed by a computing device, and comprises the steps of: collecting a plurality of images generated by capturing images of a traffic light located in a prescribed area; extracting a plurality of pieces of signal state information from each of the plurality of collected images; and determining final signal information about the traffic light by using the extracted plurality of pieces of signal state information.

### CROSS-REFERENCE TO RELATED APPLICATIONS

The present application is a Continuation of International Application No. PCT/KR2023/001371 filed on Jan. 31, 2023, which is based upon and claims the benefit of priority to Korean Patent Application No. 10-2022-0102109 filed on Aug. 16, 2022. The disclosures of the above-listed applications are hereby incorporated by reference herein in their entirety.

### TECHNICAL FIELD

Various embodiments of the present invention relate to a method, apparatus, and computer program for recognizing signal information for autonomous driving of a vehicle.

### BACKGROUND ART

For convenience of a user driving a vehicle, various sensors, electronic devices (e.g., an advanced driver assistance system (ADAS)), and the like tend to be provided, and in particular, development of a technology of an autonomous driving system for a vehicle, which recognizes a surrounding environment without a driver's intervention and automatically autonomously drives to a given destination depending on the recognized surrounding environment, is being actively conducted.

Here, the autonomous driving vehicle is a vehicle provided with an autonomous driving system function of recognizing a surrounding environment without a driver's intervention and automatically driving to a given destination depending on the recognized surrounding environment.

The autonomous driving system performs positioning, recognizing, predicting, planning, and controlling for autonomous driving.

Here, the positioning may be an operation of estimating a position, attitude, speed, and the like of an autonomous driving vehicle, and the recognizing may be an operation of recognizing whether there are vehicles, pedestrians, obstacles, and the like near the autonomous driving vehicle, distances, speeds, types of roads, and traffic signals. In addition, the predicting may be an operation of predicting future states (e.g., future positions, speeds, routes, and the like) of nearby vehicles, pedestrians, and the like and possible risk situations (e.g., a collision) in advance, the planning may be an operation of determining the most preferable behavior (e.g., a route, a speed, an acceleration, and the like) of the autonomous driving vehicle, and lastly, the controlling may be an operation of controlling the movement (brake, acceleration, steering wheel, and the like) of the autonomous driving vehicle so that the autonomous driving vehicle drives as planned.

For example, the autonomous driving vehicle may be controlled to recognize a surrounding environment, reflect the result of the recognition to establish a driving plan, and drive according to the collected driving plan, and here, a recognition target may include not only road users positioned near the autonomous driving vehicle (e.g., users on a road, such as vehicles, motorcycles, pedestrians, and the like near the autonomous driving vehicle), but also a signal state of a traffic light.

Meanwhile, the autonomous driving system may analyze images of the traffic light acquired through an imaging device such as a camera in order to recognize the signal state of the traffic light and may analyze images of the traffic light acquired every moment (frame) to recognize the signal state of the traffic light, and when analyzing one image of a specific frame, an abnormal result can be output, resulting in a problem that it is difficult to secure accuracy and robustness.

In addition, even when images for a specific frame are incorrectly recognized due to backlighting, bad weather, degradation of camera performance, or the like, the result of the recognition is output without any correction, resulting in a problem that stability cannot be secured when such a result is reflected in a driving plan.

In addition, even though a portion representing a signal state in the captured image of the traffic light is a part of the image, the conventional autonomous driving vehicle analyzes the entire image of the traffic light to recognize the signal state of the traffic light, resulting in a problem that it is inefficient in terms of a calculation amount and a calculation speed.

### DISCLOSURE

### Technical Problem

The present invention is directed to solving the above-described conventional problems and is directed to providing a method, apparatus, and computer program for recognizing signal information for autonomous driving of a vehicle, which are capable of securing recognition accuracy and robustness by recognizing a signal of a traffic light using a plurality of images generated by capturing images of the traffic light and deriving a more accurate and robust result of signal recognition without any influence from performance degradation of a sensor, bad weather, backlighting, and the like by determining final signal information of the traffic light considering time-series information (e.g., a signal change sequence of the traffic light) about the traffic light.

Objects of the present invention are not limited to the above-described object, and other objects that are not mentioned will be clearly understood by those skilled in the art from the following descriptions.

### Technical Solution

A method of recognizing signal information for autonomous driving of a vehicle, which is performed by a computing device, according to one embodiment of the present invention for achieving the above object includes collecting a plurality of images generated by capturing images of a traffic light located in a predetermined region, extracting a plurality of pieces of signal state information from each of the plurality of collected images, and determining final signal information of the traffic light using the plurality of pieces of extracted signal state information.

In various embodiments, the extracting of the plurality of pieces of signal state information may include identifying a traffic light region of each of the plurality of collected images based on location information of the traffic light and positioning information of an autonomous driving vehicle, which are recorded on precise map data corresponding to the predetermined region, cropping only the identified traffic light region from each of the plurality of collected images and generating a plurality of traffic light images, and analyzing each of the plurality of generated traffic light images and extracting the plurality of pieces of signal state information.

In various embodiments, the extracting of the plurality of pieces of signal state information may include analyzing a first image among the plurality of collected images using a pre-trained signal classification model and extracting first signal state information of the first image.

In various embodiments, the extracting of the first signal state information may include analyzing the first image using the pre-trained signal classification model and classifying a signal of the traffic light included in the first image as one signal class of a plurality of preset signal classes, imparting a probability score to each of the plurality of preset signal classes according to the classified one signal class based on a predefined probability score matrix which is a matrix on which a signal state-specific probability score of each of the plurality of preset signal classes is recorded, and extracting signal class-specific probability score information including the probability score of each of the plurality of preset signal classes as the first signal state information based on the imparted probability score.

In various embodiments, the determining of the final signal information may include imparting a probability score of each of a plurality of preset signal classes using the plurality of pieces of extracted signal state information, summing the probability score imparted to each of the plurality of preset signal classes to calculate a summed value of the probability score of each of the plurality of preset signal classes, selecting a signal corresponding to a signal class having a greatest calculated summed value of the probability score among the plurality of preset signal classes as fusion signal information, and determining the final signal information using the selected fusion signal information.

In various embodiments, the determining of the final signal information using the selected fusion signal information may include determining whether a change from a first signal to a second signal is possible based on a signal change sequence of the traffic light when final signal information determined at a first time point is the first signal and fusion signal information selected for a predetermined period starting from the first time point is the second signal, and determining final signal information at a second time point after a predetermined period has elapsed from the first time point depending on whether the change from the first signal to the second signal is possible.

In various embodiments, the determining of whether the change from the first signal to the second signal is possible may include loading a signal change sequence matched with identification information of the traffic light among a plurality of signal change sequences recorded on precise map data corresponding to the predetermined region or a signal change sequence matched with identification information of the traffic light among a plurality of signal change sequences stored in a separate data structure, and determining whether the change from the first signal to the second signal is possible using the loaded signal change sequence.

In various embodiments, the determining of the final signal information at the second time point may include determining that the second signal is the final signal information at the second time point when it is determined that the change from the first signal to the second signal is possible based on the signal change sequence of the traffic light.

In various embodiments, the determining of the final signal information at the second time point may include maintaining the final signal information at the second time point as the first signal when it is determined that the change from the first signal to the second signal is not possible based on the signal change sequence of the traffic light, and determining that final signal information at a third time point after a predetermined period has elapsed from the second time point is the second signal when the fusion signal information selected for the predetermined period starting from the second time point is the second signal.

In various embodiments, the determining that the final signal information at the third time point after the predetermined period has elapsed from the second time point is the second signal may include changing the final signal information after the predetermined period has elapsed from the second time point to an “Unknown” state when the fusion signal information selected for the predetermined period starting from the second time point is the second signal and determining that the final signal information at the third time point is the second signal when the fusion signal information selected at the third time point, which is after a predetermined period has elapsed from a time point when the final signal information is changed to the “Unknown” state, is the second signal.

In various embodiments, the determining of the final signal information may include generating input data using the plurality of pieces of extracted signal state information and inputting the generated input data into a pre-trained artificial intelligence model and extracting the final signal information as result data.

In various embodiments, the generating of the input data may include generating a plurality of pieces of first tensor data having a one-dimensional data structure using the plurality of pieces of signal state information extracted from the plurality of images corresponding to the same frame and combing the plurality of pieces of generated first tensor data to generate one piece of second tensor data having a two-dimensional data structure, and combining a plurality of second pieces of tensor data of each of the plurality of different frames to generate one data box having a three-dimensional data structure as input data.

In various embodiments, the generating of the input data may include preprocessing the plurality of pieces of extracted signal state information using an exponential function based on softmax to convert signal class-specific probability score information corresponding to each of the plurality of pieces of extracted signal state information into a value within a predetermined range.

In various embodiments, the pre-trained artificial intelligence model may be a model that is trained using training data generated based on a plurality of images collected by capturing images of a plurality of traffic lights, and the training data may include first input data, second input data, first right answer data of the first input data, and second right answer data of the second input data when the first input data is generated based on the plurality of images collected by capturing images of a first traffic light and the second input data is generated based on the plurality of images collected by capturing images of a second traffic light and may further include a padding box inserted between the first input data and the second input data and a padding stick that is inserted between the first right answer data and the second right answer data and is the same frame as the padding box.

A computing device for performing a method of recognizing signal information for autonomous driving of a vehicle according to another embodiment of the present invention for achieving the above object includes a processor, a network interface, a memory, and a computer program loaded in the memory and executed by the processor, wherein the computer program may include an instruction to collect a plurality of images generated by capturing images of a traffic light located in a predetermined region, an instruction to extract a plurality of pieces of signal state information from each of the plurality of collected images, and an instruction to determine final signal information of the traffic light using the plurality of pieces of extracted signal state information.

A computer program stored in a computing device-readable recording medium coupled with a computing device to execute a method of recognizing signal information for autonomous driving of a vehicle according to still another embodiment of the present invention for achieving the above object includes collecting a plurality of images generated by capturing images of a traffic light located in a predetermined region, extracting a plurality of pieces of signal state information from each of the plurality of collected images, and determining final signal information of the traffic light using the plurality of pieces of extracted signal state information.

Other specific items of the present invention are included in the detailed description and drawings.

### Advantageous Effects

According to various embodiments of the present invention, by recognizing a signal of a traffic light using a plurality of images generated by capturing images of the traffic light, it is possible to secure recognition accuracy and robustness, and by determining final signal information of the traffic light considering time-series information of the traffic light (e.g., a signal change sequence of the traffic light), it is possible to derive a more accurate and robust result of the signal recognition without any influence from degradation of performance of a sensor, bad weather, backlighting, and the like.

### DESCRIPTION OF DRAWINGS

FIG. 1 is a view illustrating an autonomous driving system according to one embodiment of the present invention.

FIG. 2 is a hardware configuration diagram of a computing device for performing a method of recognizing signal information for autonomous driving of a vehicle according to another embodiment of the present invention.

FIG. 3 is a flowchart of a method of recognizing signal information for autonomous driving of a vehicle according to still another embodiment of the present invention.

FIG. 4 is a flowchart for describing a method of extracting signal state information from an image according to various embodiments.

FIG. 5 is a view for describing a process of extracting a traffic light region from an image according to various embodiments.

FIGS. 6A and 6B are a view for describing a process of extracting a predefined probability score matrix and signal class-specific probability score information using the predefined probability score matrix according to various embodiments.

FIG. 7 is a flowchart for describing a method of generating final signal information using a rule base model according to various embodiments.

FIG. 8 is a view illustrating the rule base model applicable to various embodiments.

FIGS. 9 and 10 are views for describing a process of selecting fusion signal information according to various embodiments.

FIGS. 11A and 11B are a view for describing a process of verifying the fusion signal information based on a signal change sequence of the traffic light according to various embodiments.

FIG. 12 is a flowchart for describing a method of generating final signal information using an artificial intelligence model according to various embodiments.

FIG. 13 is a view illustrating the artificial intelligence model applicable to various embodiments.

FIGS. 14A, 14B, 14C, 15A and 15B are views for describing a process of generating input data of the artificial intelligence model according to various embodiments.

### MODES OF THE INVENTION

The advantages and characteristics of the present invention and a method for achieving the advantages and characteristics will become more apparent from the embodiments described in detail in conjunction with the accompanying drawings. However, the present invention is not limited to the disclosed embodiments, but may be implemented in various different ways, the embodiments are provided to only complete the disclosure of the present invention and to allow those skilled in the art to understand the gist of the present invention, and the present invention is defined by the scope of the claims.

Terms used herein are intended to describe embodiments and are not intended to limit the present invention. In the present specification, the singular form also includes a plural form unless specifically stated otherwise. The terms “comprises” and/or “comprising” used herein do not preclude the presence or addition of one or more components other than stated components. Throughout the specification, the same reference numeral denotes the same component, and the term “and/of” includes each of the stated components and all of one or more combinations thereof. Even though the terms “first,” “second,” and the like are used to describe various components, it is apparent that these components are not limited by these terms. These terms are only used to distinguish one component from another component. Accordingly, it is apparent that a first component to be described below may be a second component within the technical spirit of the present invention.

Unless otherwise defined, all terms (including technical and scientific terms) used herein can be used with meanings that can be commonly understood by those skilled in the art to which the present invention pertains. In addition, terms previously defined in generally used dictionaries are not ideally or excessively construed unless clearly defined specially.

Term such as “unit” or “module” used herein refers to a hardware component such as a field programmable gate array (FPGA) or an application specific integrated circuit (ASIC), and the “unit” or “module” performs certain roles. However, the “unit” or “module” is not limited to software or hardware. The “unit” or “module” may be disposed in an addressable storage medium and configured to reproduce one or more processors. Accordingly, as an example, the term “unit” or “module” includes software components, object-oriented software components, class components, and task components, processes, functions, attributes, procedures, subroutines, segments of program code, drivers, firmware, microcode, circuits, data, databases, data structures, tables, arrays, and variables. Functions provided inside components and the “unit” or “module” are coupled in a fewer number of components and “units” or “modules or further separated into additional components and “units” or “modules.”

The terms “below,” “beneath,” “lower,” “above,” “upper,” and the like, which are spatially relative terms, can be used to easily describe the correlation between one component and other components as illustrated in the drawings. The spatially relative terms should be understood as the terms including different directions of components in use or in operation in addition to directions illustrated in the drawings. For example, when a component illustrated in a drawing is flipped, the component described as being positioned “below” or “beneath” another component may be disposed “above” the other component. Accordingly, the exemplary term “below” may include both upward and downward. The component may also be oriented in a different direction, and thus the spatially relative terms can be construed according to orientation.

In the present specification, a computer is any type of hardware device including at least one processor, and according to embodiments, its meaning can be understood to also include software components operated in the corresponding hardware device. For example, the meaning of “computer” can be understood to include all of a smartphone, a tablet PC, a desktop, a notebook PC, and user clients and applications driven in each device, and in addition, is not limited thereto.

Hereinafter, embodiments of the present invention will be described in detail with reference to the accompanying drawings.

Operations described herein are described as being performed by a computer, but the subject of each operation is not limited thereto, and according to embodiments, at least some of the operations may be performed by a different device.

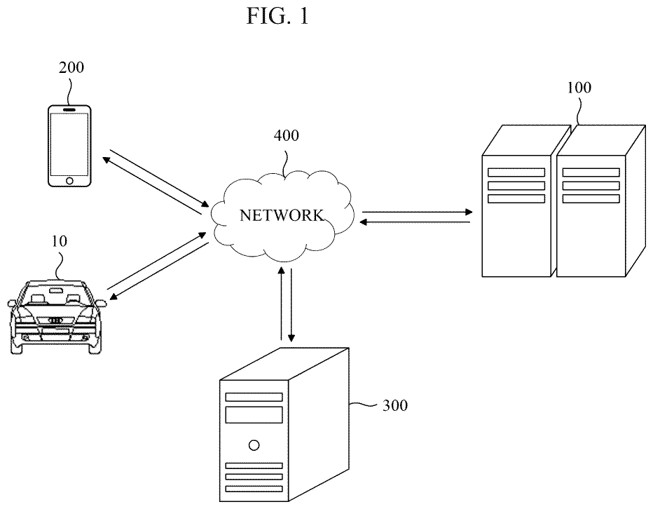

FIG. 1 is a view illustrating an autonomous driving system according to one embodiment of the present invention.

Referring to FIG. 1, the autonomous driving system according to one embodiment of the present invention may include a computing device 100, a user terminal 200, an external server 300, and a network 400.

Here, the autonomous driving system illustrated in FIG. 1 is formed according to one embodiment, components thereof are not limited to the embodiment illustrated in FIG. 1, and some components may be added, changed, or omitted as needed.

In one embodiment, the computing device 100 is for autonomous driving control of the autonomous driving vehicle 10 and may recognize a surrounding environment of the autonomous driving vehicle 10. For example, the computing device 100 may recognize signal information of a traffic light located in a predetermined region in which the autonomous driving vehicle 10 drives.

In various embodiments, the computing device 100 may recognize signal information of a traffic light located in a predetermined region. For example, the computing device 100 may analyze a plurality of images generated by capturing images of the traffic light, extract a plurality of pieces of signal state information, and determine final signal information of the traffic light using the plurality of pieces of extracted signal state information.

In various embodiments, the computing device 100 may determine a driving plan of the autonomous driving vehicle 10 using the final signal information determined according to the above method and perform autonomous driving control of the autonomous driving vehicle 10 according to the determined driving plan. Here, the computing device 100 may be provided inside the autonomous driving vehicle 10 and implemented to perform only the autonomous driving control of the autonomous driving vehicle 10, but is not limited thereto, and in some cases, the computing device 100 may be implemented as a central server provided separately outside the autonomous driving vehicle 10 to perform autonomous driving control of all vehicles positioned in the predetermined region.

In various embodiments, the computing device 100 may be connected to the user terminal 200 through the network 400 to provide the user terminal 200 with information related to the autonomous driving vehicle 10 (e.g., positioning information, recognition information, driving plan information, and the like).

Here, the user terminal 200 may include a navigation system, a personal communication system (PCS), a global system for mobile system (GSM), a personal digital cellular (PDC), a personal handyphone system (PHS), a personal digital assistant (PDA), internal mobile telecommunication (IMT)-2000, code division multiple access (CDMA)-2000, W-CDMA, a wireless broadband Internet (WiBro) terminal, a smartphone, a smartpad, and a tablet PC, but is not limited thereto.

In addition, here, the network 400 may be a connection structure in which information may be exchanged between nodes such as a plurality of terminals and servers. For example, the network 400 may include a local area network (LAN), a wide area network (WAN), the Internet (world wide web (WWW)), a wired/wireless data communication network, a phone network, a wired/wireless television communication network, and the like.

In addition, here, the wireless data communication network may include 3G, 4G, 5G, 3^{rd} generation partnership project (3GPP), 5GPP, Long Term Evolution (LTE), World Interoperability for Microwave Access (WiMAX), Wi-Fi, the Internet, a LAN, a WAN, a personal area network (PAN), radio frequency (RF), a Bluetooth network, a near-field communication (NFC) network, a satellite broadcasting network, an analog broadcasting network, a digital multimedia broadcasting (DMB) network, and the like, but is not limited thereto.

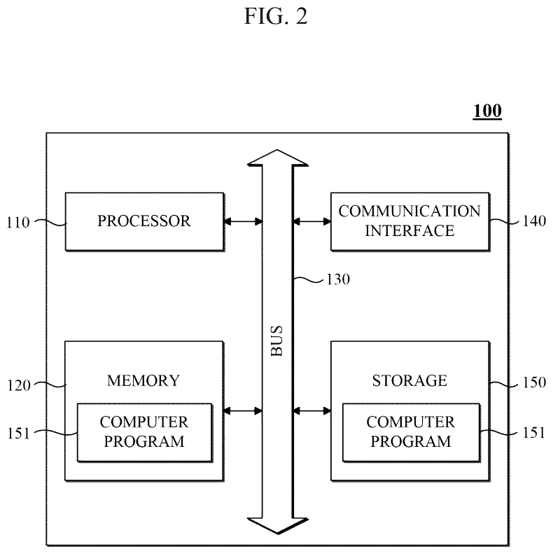

In one embodiment, the external server 300 may be connected to the computing device 100 through the network 400 to store and manage various types of information and data required for performing a method of recognizing signal information for autonomous driving of a vehicle or to receive, store, and manage various types of information and data generated by performing the method of recognizing signal information. For example, the external server 300 may be a storage server provided separately outside the computing device 100 but is not limited thereto. Hereinafter, a hardware configuration of the computing device 100 for performing the method of recognizing signal information for autonomous driving of a vehicle will be described with reference to FIG. 2.

FIG. 2 is a hardware configuration diagram of a computing device for performing a method of recognizing signal information for autonomous driving of a vehicle according to another embodiment of the present invention.

Referring to FIG. 2, in various embodiments, the computing device 100 may include one or more processors 110, a memory 120 for loading a computer program 151 performed by the processor 110, a bus 130, a communication interface 140, and a storage 150 for storing the computer program 151. Here, FIG. 2 illustrates only components related to the embodiment of the present invention. Accordingly, those skilled in the art to which the present invention pertains can know that general-purpose components other than the components illustrated in FIG. 2 may be further included.

The processor 110 controls the overall operation of the components of the computing device 100. The processor 110 may include a central processing unit (CPU), a microprocessor unit (MPU), a micro controller unit (MCU), or a processor of any form well known in the art of the present invention.

In addition, the processor 110 may perform calculations for at least one application or program for executing the method according to embodiments of the present invention, and the computing device 100 may have one or more processors.

In various embodiments, the processor 110 may further include a random access memory (RAM) (not illustrated) and a read-only memory (ROM) (not illustrated) for temporarily and/or permanently storing a signal (or data) processed inside the processor 110. In addition, the processor 110 may be implemented in the form of a system on chip (SOC) including at least one of a graphics processing unit, a RAM, and a ROM.

The memory 120 stores various types of data, instructions, and/or information. The memory 120 may load the computer program 151 from the storage 150 to execute methods/operations according to various embodiments of the present invention. When the computer program 151 is loaded in the memory 120, the processor 110 may perform the methods/operations by executing one or more instructions forming the computer program 151. The memory 120 may be implemented as a volatile memory such as a RAM, but the technical scope of the present invention is not limited thereto.

The bus 130 provides a communication function between the components of the computing device 100. The bus 130 may be implemented as various types of buses such as an address bus, a data bus, a control bus, and the like.

The communication interface 140 supports wired/wireless Internet communication of the computing device 100. In addition, the communication interface 140 may support various communication methods other than Internet communication. To this end, the communication interface 140 may include a communication module well known in the art of the present invention. In some embodiments, the communication interface 140 may be omitted.

The storage 150 may non-temporarily store the computer program 151. When a process of recognizing signal information for autonomous driving of a vehicle is performed through the computing device 100, the storage 150 may store various types of information to provide the process of recognizing signal information for autonomous driving of a vehicle.

The storage 150 may include a non-volatile memory such as a ROM, an erasable programmable ROM (EPROM), an electrically EPROM (EEPROM), a flash memory, and the like, a hard disk, a detachable disk, or any type of a computer-readable recording medium well known in the art to which the present invention pertains.

The computer program 151 may include one or more instructions that allow the processor 110 to perform the methods/operations according to various embodiments of the present invention when loaded in the memory 120. That is, the processor 110 may perform the methods/operations according to various embodiments of the present invention by executing the one or more instructions.

In one embodiment, the computer program 151 may include one or more instructions to perform the method of recognizing signal information for autonomous driving of a vehicle, which includes collecting a plurality of images generated by capturing images of a traffic light located in a predetermined region, extracting a plurality of pieces of signal state information from each of the plurality of collected images, and determining final signal information of the traffic light using the plurality of pieces of extracted signal state information.

Operations of the method or algorithm described in relation to the embodiment of the present invention may be directly implemented by hardware, implemented by a software module executed by hardware, or implemented by a combination thereof. The software module may reside in a RAM, a ROM, an EPROM, an EEPROM, a flash memory, a hard disk, a detachable disk, a CD-ROM, or any type of a computer-readable recording medium well known in the art to which the present invention pertains.

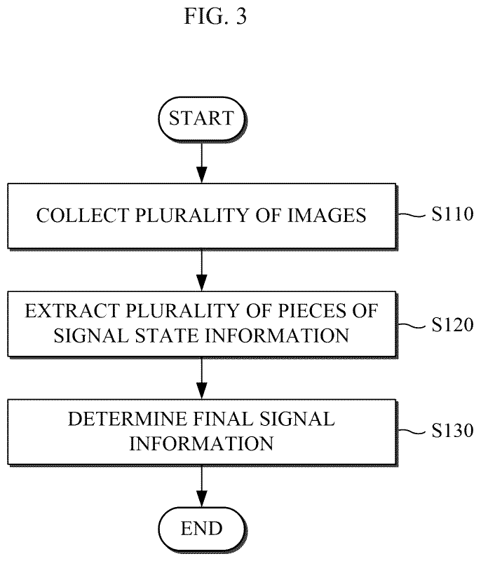

The components of the present invention may be coupled to a computer that is hardware and implemented by a program (or an application) for execution and stored in a medium. The components of the present invention may be executed by software programming or software elements, and similarly, the embodiment may be implemented by a programing or scripting language, such as C, C++, Java, an assembler, or the like, in addition to various algorithms implemented by a combination of a data structure, processes, routines, or other programming components. Functional aspects may be implemented by an algorithm executed by one or more processors. Hereinafter, the method of recognizing signal information for autonomous driving of a vehicle, which is performed by the computing device 100, will be described with reference to FIGS. 3 to 15.

FIG. 3 is a flowchart of a method of recognizing signal information for autonomous driving of a vehicle according to still another embodiment of the present invention.

Referring to FIG. 3, in operation S110, the computing device 100 may collect a plurality of images.

In various embodiments, the computing device 100 may collect a plurality of images generated by capturing images of a traffic light located in a predetermined region.

For example, the autonomous driving vehicle 10 may include a plurality of camera modules and capture images of the traffic light by operating each of the plurality of camera modules to generate a plurality of images including the traffic light, and the computing device 100 may collect the plurality of images generated through the plurality of camera modules.

Here, the traffic light included in the plurality of images may be the same traffic light, but is not limited thereto, and in some cases, may be a plurality of traffic lights that output the same signal information (e.g., a plurality of traffic lights that output the same signal at an intersection).

In addition, here, since the method of recognizing signal information for autonomous driving of a vehicle, which is performed by the computing device 100, is a method of analyzing a plurality of images including a specific traffic light and recognizing a signal output by the specific traffic light, the plurality of images may be images generated by capturing images of the specific traffic light at the same time point by operating a plurality of camera modules at the same time point, that is, images of the same frame. For example, the computing device 100 may collect a plurality of images generated at a first time point (e.g., a first frame) in order to recognize signal information at the first time point and collect a plurality of images generated at a second time point (e.g., a second frame) in order to recognize signal information at the second time point.

In various embodiments, the computing device 100 may collect a plurality of videos generated by capturing video of a traffic light for a predetermined period using the plurality of camera modules provided in the autonomous driving vehicle 10 and acquire a plurality of images captured at the same time point by capturing images of a screen of the same frame with respect to each of the plurality of collected videos.

In operation S120, the computing device 100 may analyze each of the plurality of images collected through operation S110 and extract a plurality of pieces of signal state information.

In various embodiments, the computing device 100 may crop only a traffic light region from each of the plurality of images, analyze only the cropped traffic light region, and extract a plurality of pieces of signal state information. That is, the computing device 100 may analyze only the traffic light region included in the image rather than analyzing the entire image, thereby more efficiently extracting signal state information in terms of a calculation amount and a calculation speed.

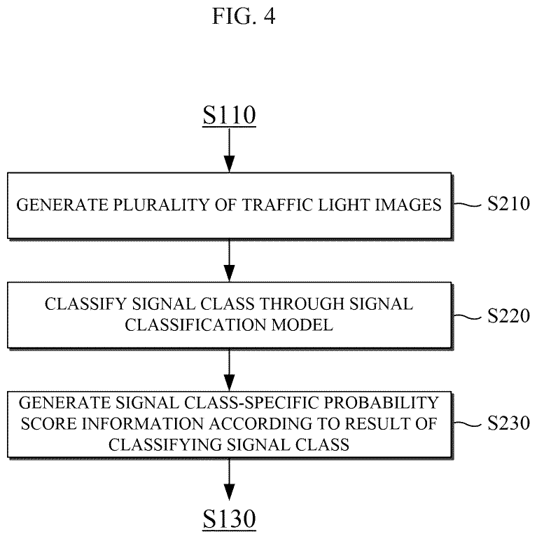

FIG. 4 is a flowchart for describing a method of extracting signal state information from an image according to various embodiments.

Referring to FIG. 4, in operation S210, the computing device 100 may generate a plurality of traffic light images using a plurality of images generated by capturing images of a traffic light located in a predetermined region.

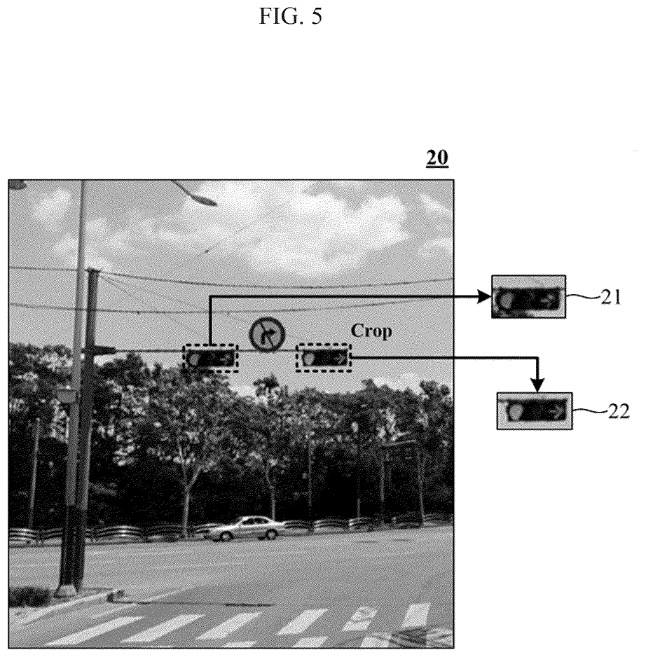

More specifically, first, referring to FIG. 5, when collecting an image 20 including the traffic light, the computing device 100 may identify a traffic light region from the image 20. For example, the computing device 100 may identify the traffic light region included in the image 20 based on location information of the traffic light and positioning information of the autonomous driving vehicle 10 (e.g., information about a position, attitude, speed, and the like on a precise map of the autonomous driving vehicle 10) recorded on precise map data corresponding to the predetermined region.

Here, the precise map data on the predetermined region may be map data constructed in advance to determine a driving plan of the autonomous driving vehicle 10 that drives in the predetermined region and may include not only line and lane information, road information on the predetermined region (e.g., a transportation vulnerable zone, a school zone, and the like), a reference route, a target speed, an upper limit speed, and information on a region where yielding is required), but also location information of a traffic light installed in the predetermined region.

In addition, here, the location information of the traffic light may be information representing the position of the traffic light and, for example, may include coordinate information (e.g., (X, Y, Z) information) corresponding to the position of the traffic light or latitude, longitude, and altitude information corresponding to the position of the traffic light, but is not limited thereto.

Then, the computing device 100 may crop only the traffic light region identified from the image 20 to generate traffic light images 21 and 22. In this case, as illustrated in FIG. 5, when two or more traffic light regions are identified in one image 20, the computing device 100 may crop each of the two or more traffic light regions to generate the traffic light images 21 and 22, but is not limited thereto, and in some cases, may crop only one traffic light region among the two or more traffic light regions.

Here, since various technologies for the method of cropping only a specific region from one image are known, and various known technologies may be selectively applied, in the present specification, a specific method of cropping only the traffic light region from the image including the traffic light to generate the traffic light image is not limited.

In various embodiments, the computing device 100 may convert and calibrate coordinate information representing the position of the traffic light according to the coordinate information of the image 20 to identify the traffic light region included in the image 20 and crop only the traffic light region from the image 20 to generate the traffic light image.

In this case, when errors occur during conversion and calibration of the coordinate information representing the position of the traffic light, the traffic light region included in the image 20 is not accurately identified, and thus, since the traffic light image including no traffic light region or only at least a part of the traffic light may be generated, the computing device 100 may crop a greater region than the traffic light region identified from the image 20 by a predetermined size.

In operation S220, the computing device 100 may analyze the plurality of traffic light images generated through operation S210 to extract a plurality of pieces of signal state information.

In various embodiments, the computing device 100 may analyze the plurality of traffic light images using a pre-trained signal classification model to extract the plurality of pieces of signal state information of each of the plurality of traffic light images.

Here, the pre-trained signal classification model may be a model that is pre-trained using traffic light information having labeled information about one of a plurality of preset signal classes as training data and may be a model (e.g., a convolutional neural network (CNN), a multi-layer perceptron (MLP), or the like) that receives a specific traffic signal image to classify the specific traffic signal image as one of the plurality of preset signal classes.

In addition, here, the plurality of preset signal classes may include, for example, Unknown, Off, a red signal R, a yellow signal Y, a green signal G, a red and yellow signal RY, a red and left turn signal RL, a yellow and left turn signal YL, a yellow and green turn signal YG, and a green and left turn signal GL, but are not limited thereto.

As another example, the plurality of preset signal classes may include a red signal on, a red signal off, a yellow signal on, a yellow signal off, a green signal on, a green signal off, a left turn signal on, a left turn signal off, other signals (a turn signal, a bus signal, a right arrow signal, and the like) on, and other signals off, and in this way, the plurality of preset signal classes are set in any of various ways.

The signal classification model (e.g., a neural network) may be formed of one or more network functions, and the one or more network functions may be formed of a set of interconnected calculation units that may be generally referred to as a “node.” Such “nodes” may be referred to as “neurons.” The one or more network functions include one or more nodes. The nodes forming the one or more network functions may be interconnected by one or more “links.”

In the signal classification model, the one or more nodes connected through the link may form a relative relationship between an input node and an output node. The concept of the input node and the output node is relative, and any node having an output node relationship with one node may have an input node relationship with another node, and the reverse thereof may also be true. As described above, the relationship between the input node and the output node may occur centered on the link. One input node may be connected to one or more output nodes through the link, and the reverse thereof may also be true.

In the relationship between the input node and the output node connected through one link, a value of the output node may be determined based on data input to the input node. Here, a node connecting the input node to the output node may have a weight. The weight may be variable, and in order for the signal classification model to perform a desired function, the weight may be changed by a user or an algorithm. For example, when one or more input nodes are interconnected to one output node by each link, an output node value may be determined based on values input to the input nodes connected to the output node and a weight set for the link corresponding to the input nodes.

As described above, in the signal classification model, the one or more input nodes are interconnected through the one or more links to establish the relationship between the input node and the output node within the signal classification model. Depending on the numbers of nodes and links, relationships between the nodes and the links, and a weight value imparted to each of the links in the signal classification model, characteristics of the signal classification model may be determined. For example, when the same numbers of nodes and links are present and two signal classification models having different weight values between the links are present, the two signal classification models may be recognized as being different.

Some of the nodes forming the signal classification model may form one layer based on distances from an initial input node. For example, a set of nodes for which a distance from the initial input node is n may form n layers. The distance from the initial input node may be defined by a minimum number of links that need to be passed through from the initial input node to the corresponding node. However, such definition of the layer is arbitrary for description, and an order of the layer in the signal classification model may be defined by a method that differs from the above method. For example, layers of nodes may be defined by the distance from a final output node.

The initial input node may be one or more nodes to which data is directly input without passing through the link in the relationship with other nodes among the nodes in the signal classification model. Alternatively, in a signal classification model network, the initial input node may be a node without other input nodes connected to the link in the relationship between nodes based on a link. Similarly, the final output node may be one or more nodes without the output node in the relationship with other nodes among the nodes in the signal classification model. In addition, a hidden node may be a node forming the signal classification model rather than the initial input node and the final output node. The signal classification model according to one embodiment of the present invention may be a signal classification model which has a larger number of nodes of an input layer than nodes of a hidden layer close to an output layer and has a form in which the number of nodes decreases from the input layer to the hidden layer.

The signal classification model may include one or more hidden layers. A hidden node of the hidden layer may use a previous output of a layer and an output of a nearby hidden node as an input. The number of hidden nodes of each hidden layer may be the same or different. The number of nodes of the input layer may be determined based on the number of data fields of input data and may be the same as or different from the number of hidden nodes. The input data input to the input layer may be calculated by the hidden node of the hidden layer and output by a fully connected layer (FCL) that is the output layer.

In various embodiments, the signal classification model may be a deep learning model.

The deep learning model (e.g., a deep neural network (DNN)) may be a signal classification model including a plurality of hidden layers other than the input layer and the output layer. When the DNN is used, latent structures of data may be identified. That is, latent structures of pictures, text, videos, voice, and music (e.g., an object included in a picture, content and emotion of text, content and emotion of music, and the like) may be identified.

The DNN may include a CNN, a recurrent neural network (RNN), an auto encoder, a generative adversarial networks (GAN), a restricted Boltzmann machine (RBM), a deep belief network (DBN), a Q network, a U network, a Siamese network, or the like, but is not limited thereto.

In various embodiments, a network function may include the auto encoder. Here, the auto encoder may be one type of artificial neural network for outputting output data similar to input data.

The auto encoder may include at least one hidden layer, and an odd number of hidden layers may be disposed between input and output layers. The number of nodes of each layer may decrease from the number of nodes of the input layer to the number of nodes of a middle layer that is the bottleneck layer (encoding) and then increase from the number of nodes of the bottleneck layer to the number of nodes of the output layer (symmetrically with the input layer) symmetrically with the decrease. The nodes of a dimensionality reduction layer and a dimensionality restoration layer may or may not be symmetrical. In addition, the auto encoder may perform non-linear dimensionality reduction. The numbers of input layers and output layers may correspond to the number of sensors that are left after preprocessing of the input data. In the structure of the auto encoder, the number of nodes of the hidden layer included in the encoder may have a structure that decreases away from the input layer. When the number of nodes of the bottleneck layer (a layer having the fewest nodes positioned between an encoder and a decoder) is very small, a sufficient amount of information may not be transferred, and thus a specific number of nodes or more (e.g., half the nodes of the input layer or more) may be maintained.

The neural network may be trained by at least one of supervised learning, unsupervised learning, and semi supervised learning. The training of the neural network is for the purpose of minimizing errors of an output. More specifically, the training of the neural network is a process of repeatedly inputting training data to the neural network, calculating an output of the neural network for the training data and an error of a target, backpropagating the error of the neural network from an output layer to an input layer of the neural network in order to reduce errors, and updating a weight of each node of the neural network.

First, in the case of the supervised learning, training data having a labeled right answer (i.e., labeled training data) may be used, and in the case of the unsupervised learning, training data may not be labeled with a right answer. That is, for example, the training data in the case of the supervised learning related to data classification may be data having training data labeled with categories. An error may be calculated by inputting the labeled training data to the neural network and comparing an output (a category) of the neural network with a label of the training data.

Next, in the case of the unsupervised learning related to data classification, an error may be calculated by comparing the training data as an input with the output of the neural network. The calculated error may be backpropagated from the neural network in a reverse direction (i.e., in a direction from the output layer to the input layer), and a connection weight of each node of each layer of the neural network may be updated according to the propagation. A change in an updated connection weight of each node may be determined according to a learning rate. The calculation and propagation of the error of the neural network for the input data may form a learning epoch. The learning rate may be applied differently according to the number of repetitions of the learning epoch of the neural network. For example, at the early stage of training of the neural network, the neural network can quickly secure a predetermined level of performance using a high learning rate, thereby increasing efficiency, and at the late stage of training, accuracy can be increased using a low learning rate.

In the training of the neural network, in general, the training data may be a partial set of actual data (i.e., data to be processed using the trained neural network), and thus a learning epoch in which an error of the training data decreases but an error of the actual data increases may be present. Overfitting is a phenomenon in which the error of the actual data increases due to excessive training for the training data in this way. For example, a phenomenon in which a neural network that has been trained on cats with an image of an orange cat cannot recognize cats other than orange cats may be a kind of overfitting. The overfitting may act as a cause that increases errors of a machine learning algorithm. To prevent such overfitting, a method such as increasing training data, regularization, dropout that omits some nodes of the neural network while training, and the like may be applied.

In various embodiments, the computing device 100 may analyze a specific traffic light image through the pre-trained signal classification model and extract the result of classifying the specific traffic light image as one of the plurality of preset signal classes as signal state information of the specific image.

In operation S230, the computing device 100 may generate signal class-specific probability score information by processing the plurality of pieces of signal state information considering a case in which an incorrect result may be extracted from the signal classification model due to variables such as backlighting, bad weather, degradation of performance of a camera module, and the like.

For example, the computing device 100 may analyze a first image using the signal classification model, and when a signal of a traffic light included in the first image is classified as one of the plurality of signal classes, the computing device 100 may impart a probability score to each of the plurality of preset signal classes according to one signal class based on a predefined probability score matrix and process signal state information of the first image to a form of signal class-specific probability score information including a probability score of each of the plurality of signal classes.

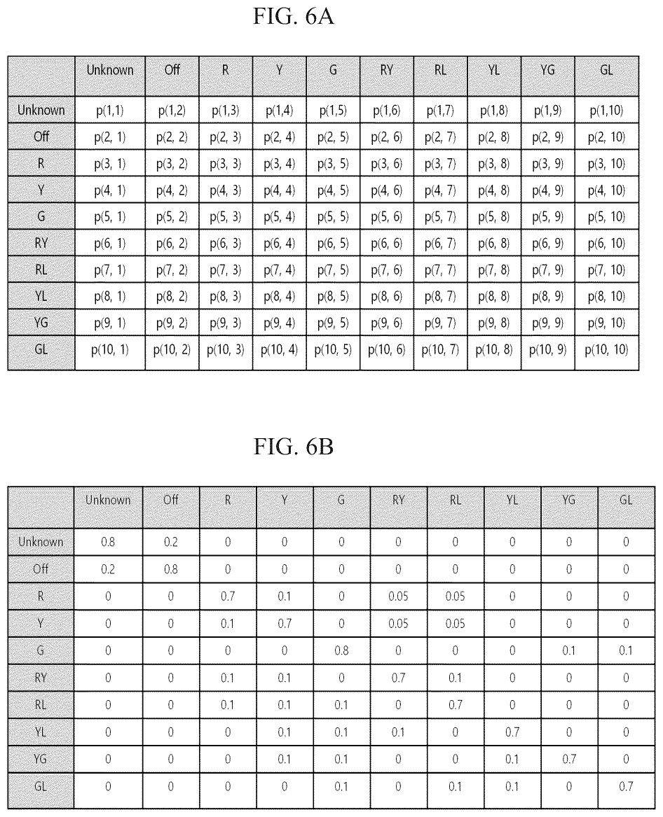

Here, as illustrated in FIGS. 6A and 6B, the predefined probability score matrix may be a matrix in which a signal state-specific probability score of each of the plurality of preset signal classes is recorded but is not limited thereto. For example, when the signal state information of the first image is a red signal R, the computing device 100 may impart 0 points to “Unknown,” 0 points to “Off,” 0.7 points to “R,” 0.1 points to “Y,” 0 points to “G,” 0.05 points to “RY,” 0.05 points to “RL,” 0 points to “RL,” 0 points to “YG,” and 0 points to “GL” according to the signal state information of the first image and process the signal state information of the first image to a form of “(Unknown, Off, R, Y, G, RY, RL, YL, YG, GL)=(0, 0, 0.7, 0.1, 0, 0.05, 0.05, 0, 0, 0).” However, the present invention is not limited thereto.

Referring back to FIG. 3, in operation S130, the computing device 100 may determine the final signal information of the traffic light using the plurality of pieces of signal state information extracted through operation S120.

In various embodiments, the computing device 100 may generate the final signal information of the traffic light using at least one of a rule base model and an artificial intelligence model.

Here, the rule base model may be a model that analyzes a plurality of pieces of signal state information based on an algorithm and determines final signal information and may be a model in which a plurality of rules (if-then) are predefined and which determines final signal information according to the plurality of predefined rules through an algorithm.

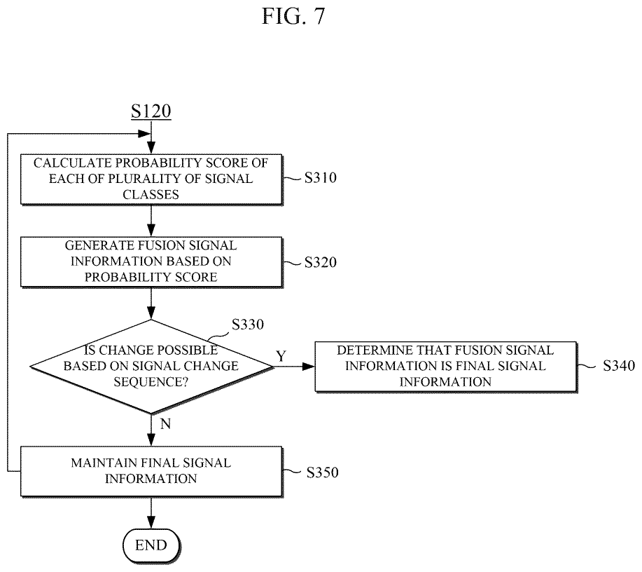

In addition, here, the artificial intelligence model may be a model that analyzes a plurality of pieces of signal state information based on data training and determines final signal information and may be a model that performs learning using input data generated based on a plurality of pieces of signal state information and right answer data (final signal information according to the plurality of pieces of signal state information) as training data to receive the plurality of pieces of signal state information and extract final signal information. Hereinafter, this will be described in more detail with reference to FIGS. 7 to 15.

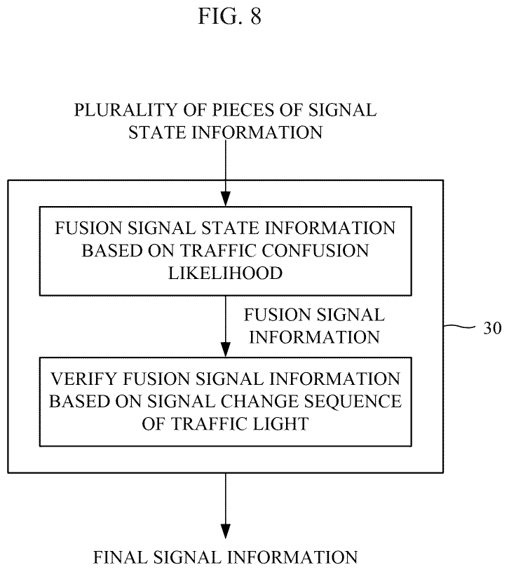

FIG. 7 is a flowchart for describing a method of generating final signal information using a rule base model according to various embodiments, and FIG. 8 is a view illustrating the rule base model applicable to various embodiments.

Referring to FIGS. 7 and 8, in various embodiments, the computing device 100 may generate final signal information of a traffic light using a rule base model 30 based on an algorithm.

In operation S310, the computing device 100 may calculate a probability score of each of a plurality of signal classes.

In various embodiments, the computing device 100 may impart a score of each of the plurality of signal classes using a plurality of pieces of signal state information extracted by analyzing a plurality of images (a plurality of traffic light images) and may sum a probability score imparted to each of the plurality of signal classes to calculate a summed value of the probability score of each of the plurality of signal classes.

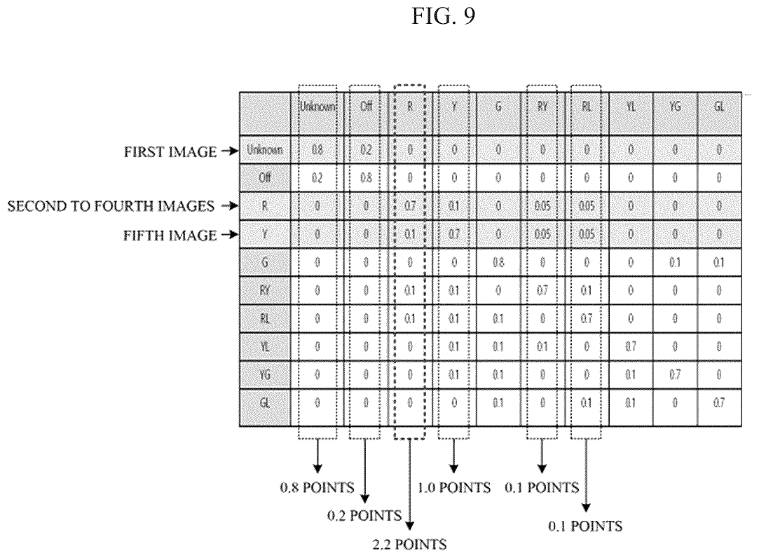

For example, as illustrated in FIG. 9, when the plurality of pieces of signal state information extracted by analyzing first to fifth images are “Unknown” (a first image), “R” (second to fourth images), and “Y” (a fifth image) and signal class-specific probability score information generated by processing each of the plurality of pieces of signal state information is “the first image=(0.8, 0.2, 0, 0, 0, 0, 0, 0, 0, 0), the second to fourth images=(0, 0, 0.7, 0.1, 0, 0.05, 0.05, 0, 0, 0), and the fifth image=(0, 0, 0.1, 0.7, 0, 0.05, 0.05, 0, 0, 0),” the computing device 100 may impart and sum the probability score of each of the plurality of signal classes (merge a plurality of pieces of signal state-specific probability score information) using each piece of signal class-specific probability score information to calculate a summed signal class-specific probability score value (e.g., “(0.8, 0.2, 2.2, 1.0, 0, 0.1, 0.1, 0, 0, 0)”).

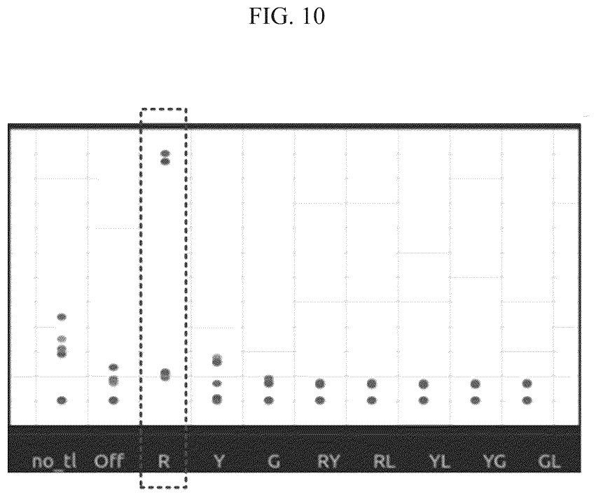

In operation S320, the computing device 100 may generate fusion signal information based on the summed probability score value calculated through operation S310. For example, the computing device 100 may select a signal corresponding to a signal class having the greatest summed probability score value among the plurality of signal classes as the fusion signal information. For example, as illustrated in FIGS. 9 and 10, when the summed signal class-specific probability score value is (0.8, 0.2, 2.2, 1.0, 0, 0.1, 0.1, 0, 0, 0), the computing device 100 may select R, which is a signal class having the greatest summed probability score value, and select a red signal, which is a signal corresponding to the signal class R, as the fusion signal information.

In operation S330, the computing device 100 may perform verification of the fusion signal information selected through operation S320.

In various embodiment, when final signal information determined at a first time point is a first signal and fusion signal information selected for a predetermined period starting from the first time point is a second signal, the computing device 100 may determine whether a change from the first signal to the second signal is possible based on a signal change sequence of the traffic light and perform verification of the fusion signal information based on the result of the determination.

Typically, the traffic light may have a predetermined sequence in changing a signal. For example, the signal of the traffic light may change from the red signal to the green signal, but there is no case in which the signal of the traffic light changes from the red signal to the yellow signal or from the green signal to the red signal. Accordingly, the computing device 100 may determine whether the fusion signal information is possible based on the signal change sequence of the traffic light considering the signal change sequence of the traffic light and verify whether the fusion signal information is accurately selected.

Here, since the signal change sequence of the traffic light is different depending on the type (three lights, four lights, or the like) of the traffic light or the installation position (a three-way intersection, a four-way intersection, a five-way intersection, or the like) of the traffic light, information about the signal change sequence of the traffic light may be matched with information of the traffic light (e.g., location information of the traffic light) and recorded on precise map data, and when the verification of the fusion signal information is required, the computing device 100 may load the information about the signal change sequence of the traffic light from the precise map data. However, the present invention is not limited thereto, and the information about the signal change sequence of the traffic light may be matched with identification information (e.g., ID information) and stored in a separate data structure.

In operation S340, when it is determined that the final signal information determined at the first time point is possible to change to the fusion signal information selected for the predetermined period starting from the first time point based on the signal change sequence of the traffic light through operation S330, the computing device 100 may determine that the fusion signal information is the final signal information at the second time point, which is after the predetermined period has elapsed from the first time point.

For example, when the final signal information (e.g., current signal information reflected in the control of the autonomous driving vehicle 10) is the first signal and the fusion information selected for the predetermined period starting from the first time point is the second signal differing from the first signal, the computing device 100 may determine whether a change from the first signal to the second signal is possible based on the signal change sequence of the traffic light, and when it is determined that the change from the first signal to the second signal is possible, the computing device 100 may determine that the second signal is the final signal information.

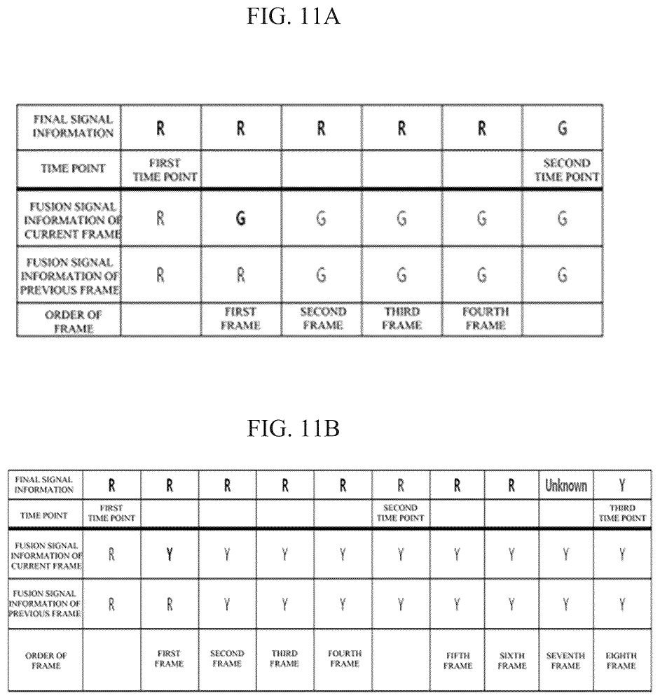

More specifically, referring to FIG. 11A, first, when the final signal information at the first time point is the red signal R and the fusion signal information selected from images of a first frame collected after the first time point is the green signal G, that is, when the final signal information at the first time point differs from the fusion signal information after the first time point, the computing device 100 may recognize that the signal of the traffic light has changed.

Then, when fusion signal information selected from images of frames (e.g., images of second to fourth frames) collected for a predetermined period after the image of the first frame is collected differs from the final signal information at the first time point and is continuously the same as the fusion signal information selected from the image of the first frame (i.e., when the green signal G is continuously selected as the fusion signal information), the computing device 100 may determine whether the signal of the traffic light may be changed from the red signal R, which is the final signal information at the first time point, to the green signal G, which is the fusion signal information selected for a predetermined frame based on the signal change sequence of the traffic light.

Here, it is described that the number of frames collected for the predetermined period is 3 (the second to fourth frames), but this is only an example, and in some cases, the number of frames collected for the predetermined period may be 1, 2, or 4 or more.

Then, when it is determined that a change from the red signal R to the green signal G is possible based on the signal change sequence of the traffic light, the computing device 100 may determine that the final signal information at the second time point after the predetermined period has elapsed from the first time point is the green signal G.

In operation S350, when it is determined that a change from the final signal information determined at the first time point to the fusion signal information selected for the predetermined period starting from the first time point through operation S330 is not possible, the computing device 100 may maintain the final signal information at the second time point, which is after the predetermined period has elapsed from the first time point, as the final signal information at the first time point.

For example, when the final signal information (e.g., current signal information reflected in the control of the autonomous driving vehicle 10) at the first time point is the first signal and the fusion information selected for the predetermined period starting from the first time point is the second signal differing from the first signal, the computing device 100 may determine whether a change from the first signal to the second signal is possible based on the signal change sequence of the traffic light, and when it is determined that the change from the first signal to the second signal is not possible, the computing device 100 may maintain the final signal information as the first signal.

More specifically, referring to FIG. 11B, when the final signal information at the first time point is the red signal R and the fusion signal information selected from the image of the first frame collected after the first time point is the yellow signal Y, that is, when the final signal information at the first time point differs from the fusion signal information after the first time point, the computing device 100 may recognize that the signal of the traffic light has changed.

Then, when the fusion signal information selected from the images of the frames (e.g., the images of the second to fourth frames) collected for the predetermined period after the image of the first frame is collected differs from the final signal information at the first time point and is continuously the same as the fusion signal information selected from the image of the first frame (i.e., when the yellow signal Y is continuously selected as the fusion signal information), the computing device 100 may determine whether a change from the red signal R, which is the final signal information at the first time point, to the yellow signal Y, which is the fusion signal information selected for the predetermined frame, is possible based on the signal change sequence of the traffic light.

Here, an example in which the number of frames collected for the predetermined period is 3 (the second to fourth frames) is described, but as described above, in some cases, the number of frames collected for the predetermined period may be 1, 2, or 4 or more.

Then, when it is determined that the change from the red signal R to the yellow signal Y is not possible based on the signal change sequence of the traffic light, the computing device 100 may maintain the final signal information at the second time point after the predetermined period has elapsed from the first time point as the red signal R.

Meanwhile, when the fusion signal information (e.g., as illustrated in FIG. 11B, the fusion signal information may be fusion signal information selected from images of fifth to eighth frames collected after the fourth frame, but is not limited thereto) is the yellow signal Y, which is the second signal, the computing device 100 may determine that the final signal information at the third time point after the predetermined period has elapsed from the second time point is the yellow signal Y.

For example, when it is determined that the change from the first signal to the second signal is not possible based on the signal change sequence of the traffic light, the computing device 100 may maintain the final signal information as the first signal, and when the fusion signal information (e.g., as illustrated in FIG. 11B, the fusion signal information may be fusion signal information selected from the images of the fifth and sixth frames, but is not limited thereto) selected from the images of the frames collected continuously after maintaining the final signal information as the first signal, is the second signal, the computing device 100 may change the final signal information after the predetermined period has elapsed from the second time point, for example, to an “Unknown” state and determine that the fusion signal information (e.g., as illustrated in FIG. 11B, the fusion signal information may be fusion signal information selected from images of seventh and eighth frames collected after the sixth frame, but is not limited thereto) selected from the images collected after the final signal information changes to the “Unknown” state is the final signal information.

That is, the computing device 100 may verify whether a change in signal is possible based on the signal change sequence of the traffic light and set the determination of the final signal information according to the result of the verification to a default, and when the same signal is continuously recognized even when the change in signal is not possible based on the signal change sequence of the traffic light, the computing device 100 relies on the continuously recognized signal preferentially to determine that the same continuously recognized signal is the final signal information.

Here, an example in which, as the second signal is continuously recognized even when the change in signal is not possible based on the signal change sequence of the traffic light, the final signal information is changed to the “Unknown” state and then changed back to the second signal has been described, but the present invention is not limited thereto, and the final signal information may be changed to any signal based on the fusion signal information selected from the image of the frame after the time point when changed to the “Unknown” state after having been changed to the “Unknown” state. For example, when the fusion signal information selected after the final signal information is changed to the “Unknown” state is the green signal G, the computing device 100 may change the final signal information from the “Unknown” state to the green signal G regardless of the fusion signal information selected before the final signal information is changed to the “Unknown” state. In addition, when the fusion signal information selected after the final signal information is changed to the “Unknown” state is the red signal R, the computing device 100 may change the final signal information from the “Unknown” state to the red signal R regardless of the fusion signal information selected before the final signal information is changed to the “Unknown” state.

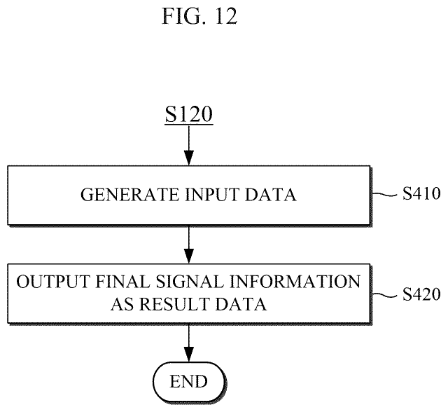

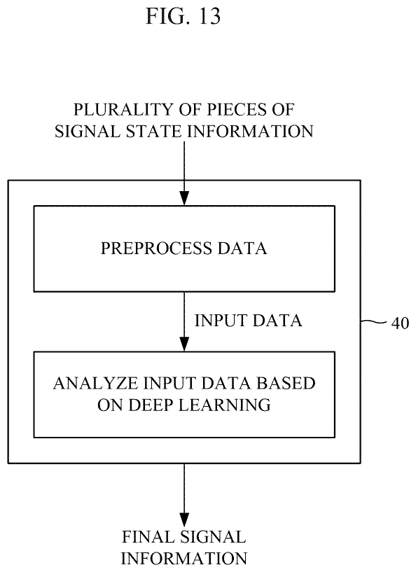

FIG. 12 is a flowchart for describing a method of generating final signal information using an artificial intelligence model according to various embodiments, and FIG. 13 is a view illustrating the artificial intelligence model applicable to various embodiments.

Referring to FIGS. 12 and 13, in various embodiments, the computing device 100 may generate final signal information of a traffic light using an artificial intelligence model 40 based on data training.

Here, the artificial intelligence model 40 may be a model that is pre-trained using a plurality of pieces of signal state information (or a plurality of pieces of signal class-specific probability score information) having labeled final signal information as training data and may be a model that extracts final signal information as a result of using the signal state information (or signal class-specific probability score information) as an input. For example, the artificial intelligence model 40 may be a deep learning model (e.g., an RNN, a long short-term memory (LSTM), or the like, which is a time-series model capable of using a signal change sequence of a traffic light) such as the signal classification model, but is not limited thereto.

In various embodiments, the computing device 100 may generate training data for training of the artificial intelligence model 40 and train the artificial intelligence model 40 using the generated training model.

Here, the training data may include input data generated by processing a plurality of images collected by capturing images of a plurality of traffic lights according to a method of generating input data (e.g., operation S410) to be described below and right answer data (e.g., signal information corresponding to the input data) corresponding to the input data.

For example, the computing device 100 may generate input data using a plurality of pieces of signal state information extracted by analyzing a plurality of images generated by capturing images of a specific traffic light, generate right answer data using the signal information of the specific traffic light, and generate a set of training data for the artificial intelligence model 40 using the input data and the right answer data. However, the present invention is not limited thereto, and the training data may further include the plurality of pieces of signal state information as well as time-series information related to a signal change sequence of the specific traffic light.

In addition, when first input data is generated based on the plurality of images collected by capturing images of a first traffic light and second input data is generated based on the plurality of images collected by capturing images of a second traffic light, the computing device 100 may combine the first input data with the second input data to generate one piece of training data.

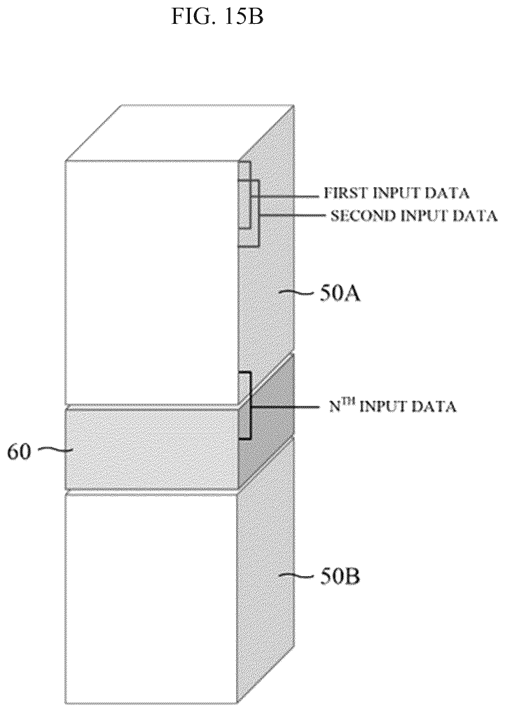

In this case, the artificial intelligence model 40 may perform learning every one frame for a plurality of frames included in the training data, and as illustrated in FIG. 15A, when first input data 50A and second input data 50B are positioned consecutively by combining the first input data 50A with the second input data 50B that correspond to different traffic lights, information included in the first input data 50A and information included in the second input data 50B may be input simultaneously, resulting in a problem of performing inaccurate learning.

Considering such a point, as illustrated in FIG. 15B, the computing device 100 may insert a padding box 60 between the first input data 50A and the second input data 50B. In addition, the computing device 100 may also insert a padding stick, which is the same frame as the padding box, between first right answer data corresponding to the first input data 50A and second right answer data corresponding to the second input data 50B.

That is, when the first input data 50A, the first right answer data, the second input data 50B, and the second right answer data are generated based on the plurality of images collected by capturing images of each of the first traffic light and the second traffic light, which are different traffic lights, the training data of the artificial intelligence model 40 may include the first input data 50A, the second input data 50B, the padding box 60 inserted between the first input data 50A and the second input data 50B, and the padding stick inserted between the first right answer data and the second right answer data. However, the present invention is not limited thereto.

Here, information included in the padding box and the padding stick may both be zero but is not limited thereto.

In operation S410, the computing device 100 may generate input data on the artificial intelligence model 40.

In various embodiments, the computing device 100 may generate input data in the form of a data box (Logit box).

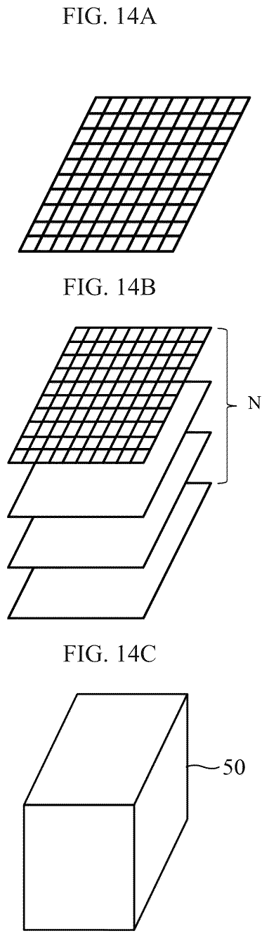

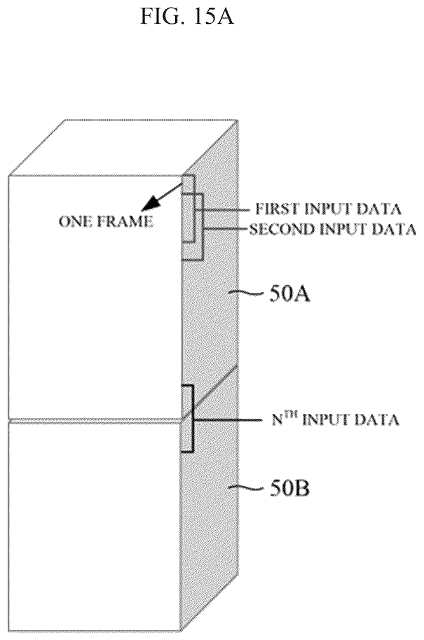

More specifically, first, the computing device 100 may generate a plurality of pieces of first tensor data having a one-dimensional data structure using the plurality of pieces of signal state information extracted from the plurality of images corresponding to the same frame and generate one piece of second tensor data (e.g., see FIG. 14A) having a two-dimensional data structure by combining the plurality of pieces of first tensor data.

For example, when each of M pieces of signal state information extracted from M images includes a probability score of each of N signal classes, the computing device 100 may generate M pieces of first tensor data (Logit) in the form of an N×1 tensor and generate second tensor data in the form of an N×M tensor by combining the M pieces of first tensor data.

Then, when the plurality of pieces of signal state information are extracted from the plurality of images corresponding to a plurality of different frames, the computing device 100 may generate a plurality of pieces of second tensor data on each of the plurality of different frames and generate one data box (e.g., 50 in FIG. 14C) having a three-dimensional data structure as input data by combining the plurality of pieces of generated second tensor data (e.g., see FIG. 14B). For example, when the M pieces of signal state information (including the probability score of each of the N signal classes) from the M images correspond to each of H different frames, the computing device 100 may generate a data box (Logit box) in the form of N×M×H as input data by combining the second tensor data in the form of H N×M.

In this case, the computing device 100 may generate one data box by combining the plurality of pieces of second tensor data, combine tensor data generated using the captured images of the same traffic light, sort the same traffic light according to the capturing order, and sequentially combine the traffic lights.

In various embodiments, the computing device 100 may preprocess the plurality of pieces of signal state information using an exponential function based on softmax to convert signal class-specific probability score information corresponding to each of the plurality of pieces of signal state information into a value within a predetermined range. That is, the computing device 100 may convert the signal class-specific probability score into a value within a range of −1 to +1 according to Equation 1 below, thereby improving performance of the artificial intelligence model 40.

$${P}_{{n}_{trans}} = \frac{{e}^{{P}_{n}}}{{\sum }_{k = 1}^{N} {e}^{{P}_{n}}} \qquad [ Equation 1 ]$$

Where Pₙ_{ₜᵣₐₙₛ} denotes a probability score value of an n^{th} preprocessed signal class, Pₙ denotes a probability score value of an n^{th} signal class, and N denotes the number of signal classes.

In operation S420, the computing device 100 may extract the final signal information of the traffic light as a result of inputting the input data generated through operation S410 to the artificial intelligence model 40.

The above signal information recognizing method for autonomous driving of a vehicle has been described with reference to the flowcharts illustrated in the drawings. For simple description, the signal information recognizing method for autonomous driving of a vehicle has been illustrated and described with a series of blocks, but the present invention is not limited to the order of the blocks, and some blocks may be performed differently from the order illustrated and described herein or performed simultaneously. In addition, the signal information recognizing method may be performed in a state in which new blocks not described in the present specification and drawings are added or some blocks are omitted or changed.

Although embodiments of the present invention have been described above with reference to the accompanying drawings, those skilled in the art to which the present invention pertains can understand that the present invention can be carried out in other specific forms without changing the technical spirit or essential features thereof. Accordingly, it should be understood that the above-described embodiments are illustrative and not restrictive in all aspects.

1. A method of recognizing signal information for autonomous driving of a vehicle, which is performed by a computing device, the method comprising:
collecting a plurality of images generated by capturing images of a traffic light located in a predetermined region;
extracting a plurality of pieces of signal state information from each of the plurality of collected images; and
determining final signal information of the traffic light using the plurality of pieces of extracted signal state information.

2. The method of claim 1, wherein the extracting of the plurality of pieces of signal state information includes:
identifying a traffic light region of each of the plurality of collected images based on location information of the traffic light and positioning information of an autonomous driving vehicle, which are recorded on precise map data corresponding to the predetermined region;
cropping only the identified traffic light region from each of the plurality of collected images and generating a plurality of traffic light images; and
analyzing each of the plurality of generated traffic light images and extracting the plurality of pieces of signal state information.

3. The method of claim 1, wherein the extracting of the plurality of pieces of signal state information includes analyzing a first image among the plurality of collected images using a pre-trained signal classification model and extracting first signal state information of the first image.

4. The method of claim 3, wherein the extracting of the first signal state information includes:
analyzing the first image using the pre-trained signal classification model and classifying a signal of the traffic light included in the first image as one signal class of a plurality of preset signal classes;
imparting a probability score to each of the plurality of preset signal classes according to the classified one signal class based on a predefined probability score matrix which is a matrix on which a signal state-specific probability score of each of the plurality of preset signal classes is recorded; and
extracting signal class-specific probability score information including the probability score of each of the plurality of preset signal classes as the first signal state information based on the imparted probability score.

5. The method of claim 3, wherein the determining of the final signal information includes:
imparting a probability score of each of a plurality of preset signal classes using the plurality of pieces of extracted signal state information;
summing the probability score imparted to each of the plurality of preset signal classes to calculate a summed value of the probability score of each of the plurality of preset signal classes and selecting a signal corresponding to a signal class having a greatest calculated summed value of the probability score among the plurality of preset signal classes as fusion signal information; and
determining the final signal information using the selected fusion signal information.

6. The method of claim 5, wherein the determining of the final signal information using the selected fusion signal information includes:
determining whether a change from a first signal to a second signal is possible based on a signal change sequence of the traffic light when final signal information determined at a first time point is the first signal and fusion signal information selected for a predetermined period starting from the first time point is the second signal; and
determining final signal information at a second time point after a predetermined period has elapsed from the first time point depending on whether the change from the first signal to the second signal is possible.

7. The method of claim 6, wherein the determining of whether the change from the first signal to the second signal is possible includes:
loading a signal change sequence matched with identification information of the traffic light among a plurality of signal change sequences recorded on precise map data corresponding to the predetermined region or a signal change sequence matched with identification information of the traffic light among a plurality of signal change sequences stored in a separate data structure; and
determining whether the change from the first signal to the second signal is possible using the loaded signal change sequence.

8. The method of claim 6, wherein the determining of the final signal information at the second time point includes determining that the second signal is the final signal information at the second time point when it is determined that the change from the first signal to the second signal is possible based on the signal change sequence of the traffic light.

9. The method of claim 6, wherein the determining of the final signal information at the second time point includes:
maintaining the final signal information at the second time point as the first signal when it is determined that the change from the first signal to the second signal is not possible based on the signal change sequence of the traffic light; and
determining that final signal information at a third time point after a predetermined period has elapsed from the second time point is the second signal when the fusion signal information selected for the predetermined period starting from the second time point is the second signal.

10. The method of claim 9, wherein the determining that the final signal information at the third time point, which is after the predetermined period has elapsed from the second time point, is the second signal includes changing the final signal information after the predetermined period has elapsed from the second time point to an “Unknown” state when the fusion signal information selected for the predetermined period starting from the second time point is the second signal and determining that the final signal information at the third time point is the second signal when the fusion signal information selected at the third time point, which is after a predetermined period has elapsed from a time point when the final signal information is changed to the “Unknown” state, is the second signal.

11. The method of claim 3, wherein the determining of the final signal information includes:
generating input data using the plurality of pieces of extracted signal state information; and
inputting the generated input data into a pre-trained artificial intelligence model and extracting the final signal information as result data.

12. The method of claim 11, wherein the generating of the input data includes:
generating a plurality of pieces of first tensor data having a one-dimensional data structure using the plurality of pieces of signal state information extracted from the plurality of images corresponding to the same frame and combing the plurality of pieces of generated first tensor data to generate one piece of second tensor data having a two-dimensional data structure; and
combining a plurality of pieces of second tensor data of each of a plurality of different frames to generate one data box having a three-dimensional data structure as input data.

13. The method of claim 11, wherein the generating of the input data includes preprocessing the plurality of pieces of extracted signal state information using an exponential function based on softmax to convert signal class-specific probability score information corresponding to each of the plurality of pieces of extracted signal state information into a value within a predetermined range.

14. The method of claim 11, wherein the pre-trained artificial intelligence model is a model that is trained using training data generated based on a plurality of images collected by capturing images of a plurality of traffic lights, and
the training data includes first input data, second input data, first right answer data of the first input data, and second right answer data of the second input data when the first input data is generated based on the plurality of images collected by capturing images of a first traffic light and the second input data is generated based on the plurality of images collected by capturing images of a second traffic light, and further includes a padding box inserted between the first input data and the second input data and a padding stick that is inserted between the first right answer data and the second right answer data and is the same frame as the padding box.

15. A computing device for performing a method of recognizing signal information for autonomous driving of a vehicle, the computing device comprising:
a processor;
a network interface;
a memory; and
a computer program loaded in the memory and executed by the processor,
wherein the computer program includes:
an instruction to collect a plurality of images generated by capturing images of a traffic light located in a predetermined region;
an instruction to extract a plurality of pieces of signal state information from each of the plurality of collected images; and
an instruction to determine final signal information of the traffic light using the plurality of pieces of extracted signal state information.

16. A computer program stored in a computing device-readable recording medium that is coupled with a computing device to execute a method of recognizing signal information for autonomous driving of a vehicle, which includes:
collecting a plurality of images generated by capturing images of a traffic light located in a predetermined region;
extracting a plurality of pieces of signal state information from each of the plurality of collected images; and
determining final signal information of the traffic light using the plurality of pieces of extracted signal state information.
